(19) United States
(12) Patent Application Publication
(10) Pub. No.: US 2009/0274190 A1
(43) Pub. Date: Nov. 5, 2009

(54) MELTING FURNACE, IN PARTICULAR ELECTRIC ARC FURNACE

(76) Inventor: Gerhard Fuchs, Kehl-Bodersweier (DE)

Correspondence Address: Muncy, Geissler, Olds & Lowe, PLLC, P.O. BOX 1364, FAIRFAX, VA, 22038-1364, US

(21) Appl. No.: 12/439,710

(22) PCT Filed: Aug. 24, 2007
(86) PCT No.: PCT/EP07/07451

§ 371 Date: Mar. 3, 2009

(30) Foreign Application Priority Data
Sep. 2, 2006 (DE) 10 2006 041 421.7

(51) Int. Cl. F27D 1/00; F27B 3/12; F27D 1/18

(52) U.S. Cl. 373/71

(57) ABSTRACT

In order to design the accommodation space of the furnace vessel of a melting furnace to be variable, so that it is adaptable to various volumes, which are required for different feedstocks (light scrap, heavy scrap) to achieve the tapping weight intended for the melting furnace, the cylindrical upper vessel part (102) comprises a first lower (105) and a second upper (106) cylindrical segment, of which one overlaps the other and is constructed to be telescopically displaceable relative to the other by at least one lifting device (21/1, 21/2).

The invention concerns a melting furnace, in particular an electric arc furnace, having a furnace vessel made of a lower vessel part and a cylindrical upper vessel part for accommodating to-be-melted feedstock, in particular scrap metal, as well as having a furnace vessel cover supported by a cover support structure.

Two or three charging operations are necessary for conventional melting furnaces to achieve the tapping weight of the melting furnace, i.e. the weight of melted liquid metal at which the furnace is tapped. This means that the melting process must be interrupted at least one time, the furnace vessel cover must be removed and feedstock of a further scrap basket must be charged. This causes losses and a prolongation of the tap-to-tap time.

For electric arc furnaces, the height of the furnace vessel is determined by the allowable length of the electrodes submerged in the vessel. If the length of the electrodes exceeds 3 to 3.5 m, electrode breakages often occur due the Lorentz forces acting on the electrodes, which breakages necessitate an interruption of the melting process. Since the electrodes must be submerged, especially during the refining process, so far that the electric arc burns on the upper surface of the bath, the height of the furnace vessel is limited for electrodes inserted through the cover by the limited allowable length of the electrodes, if interruptions caused by electrode breakages are to be avoided.

The volume of the feedstock to be charged depends upon its density. If light scrap (metal cuttings) will be melted down, then a larger volume is required to achieve the tapping weight of the molten metal than for heavy scrap. The accommodation space of the furnace vessel should be adaptable to these differing volumes in order to be able to adapt the operating conditions of the melting furnace to the supply of feedstock.

It is an object of the invention to increase the accommodation space of the furnace vessel of a melting furnace, in particular an electric arc furnace of the above-mentioned type, so much that it can accommodate the entire feedstock for the tapping weight of the furnace, so that the melting process is not required to be interrupted by supplemental charging until the tapping. In an electric arc furnace, this should be possible while complying with the allowable electrode length.

It is a further object to design the accommodation space of the furnace vessel to be variable, so that it is adaptable to the differing volumes, which are required for various feedstocks (light scrap, heavy scrap, pellets) to achieve the tapping weight intended for the melting furnace.

These objects are achieved by a melting furnace having the features of claim 1. Advantageous embodiments of the invention can be derived from the dependent claims.

In the inventive solution, the cylindrical upper vessel part comprises a first lower and a second upper cylindrical segment, of which one overlaps the other and is constructed to be telescopically displaceable relative to the other by at least one device. The size of the accommodating space of the furnace vessel for the feedstock can be thereby changed in height in accordance with how far the upper cylindrical segment is telescopically extended. This allows an enlargement and an adaptation of the accommodation space of the furnace vessel to the feedstock and, in case of an electric arc furnace in which the electrodes are inserted through the cover, also has the advantage, due to the variability of the height of the feedstock, that the cover can be lowered together with the electrode support arms during the melting process due to the decreasing height of the feedstock caused by settling of feedstock into the melting craters, so that the electrode tips of electrodes having a length limited to the allowable amount can be conveyed down to the required distance relative to the upper surface of the molten bath.

The upper cylindrical segment of the upper furnace part, which is telescopically displaceable relative to the lower cylindrical segment, can be disposed either inside or outside of the lower segment. Preferably, it is disposed outside of the lower segment, overlapping it.

The upper segment can be supported by lifting devices disposed in a distributed manner along the circumference of the furnace vessel and thus can be allocated to the upper furnace part. However, the upper cylindrical segment of the upper furnace part is preferably attached to the edge of the furnace vessel cover and is telescopically displaceable relative to the lower cylindrical segment of the upper furnace part by the cover lifting device.

In the last-mentioned case, the cover lifting device is in fact burdened with a further weight and the lifting height of the cover lifting device is substantially increased, since it must also include the telescopic displaceability and a relatively-precise vertical lifting is required therefor; however, this is achieved with the cover supporting structure, which is described in detail, having three defined bearings of the cover and the described lifting device for the cover support structure.

Due to the telescopic displaceability of the upper cylindrical segment of the upper furnace part, it is also necessary for an electric arc furnace having a separate electrode lifting device to construct it with a larger lifting height, which takes into account the telescopic displaceability. According to an advantageous embodiment of the invention, however, the cover supporting structure, in a particular case the horizontal leg of an L-shaped supporting member of the cover, supports the electrode lifting device. In this case, by adapting to the lifting height of the telescopic displaceability, it is not necessary to increase the lifting height of the electrode lifting device itself.

In view of the possible submersion depths of the electrodes into the vessel, it is further advantageous if the cover is not upwardly curved as is typical, but rather is constructed flat. The required stability can be enhanced by reinforcement ribs on the cover.

The invention will be explained in greater detail using exemplary embodiments and the assistance of nine Figures.

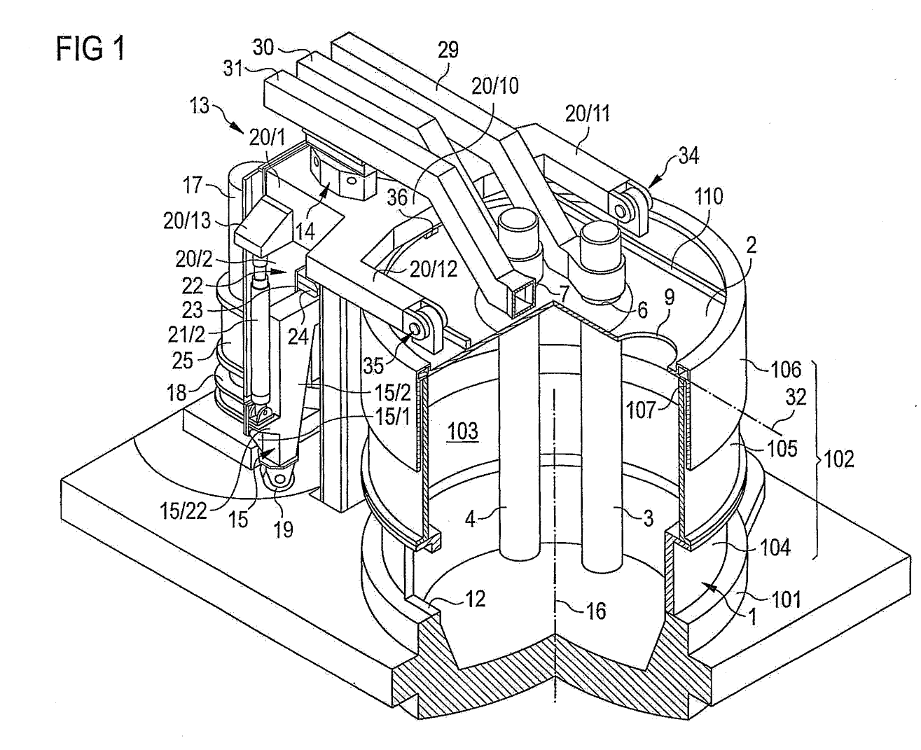

FIG. 1 shows, in a perspective view, partially in cross-section, a first embodiment of the invention, which depicts the telescopically-displaceable upper segment of the upper furnace part in the lowered state;

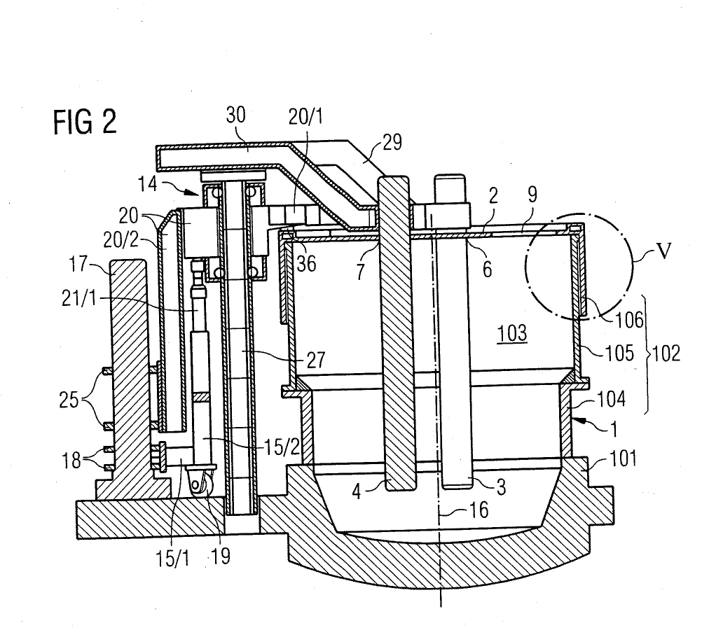

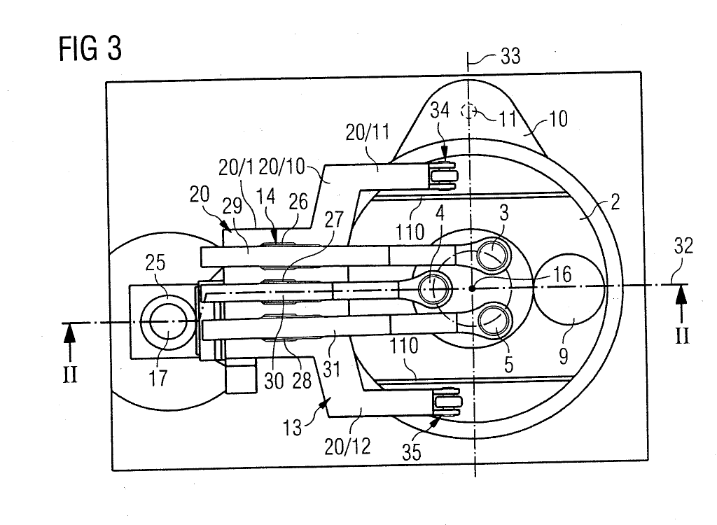

FIG. 2 shows a side view of this embodiment along the section line II-II of FIG. 3;

FIG. 3 shows a plan view of this embodiment;

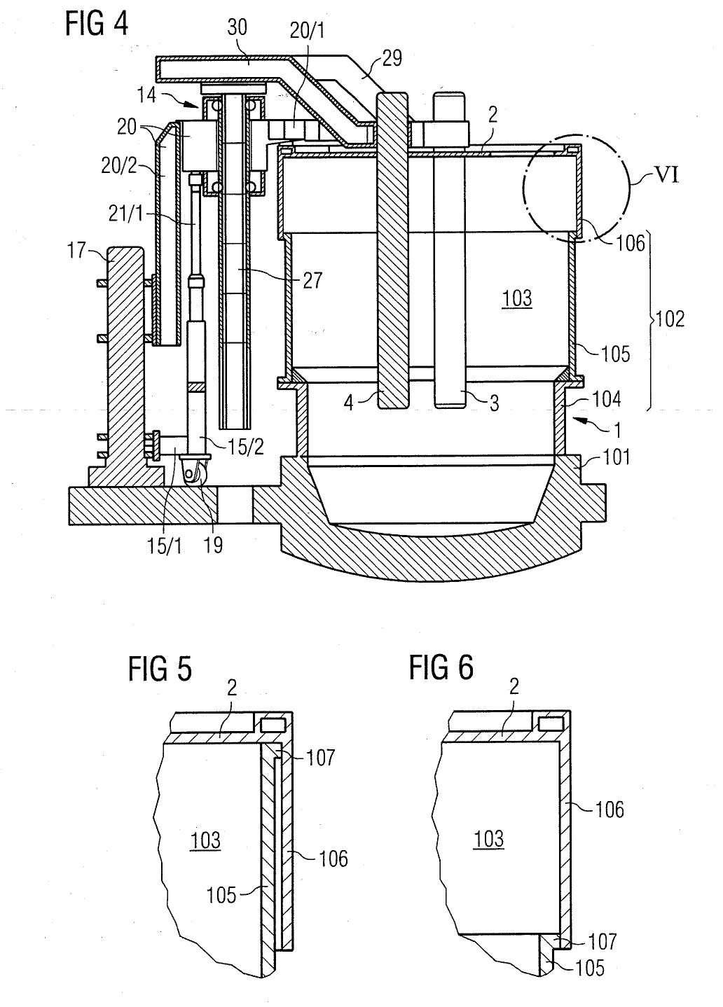

FIG. 4 shows a view of this embodiment corresponding to FIG. 2 in the lifted state of the telescopically-displaceable upper segment of the upper furnace part;

FIG. 5 and FIG. 6 show the sections marked with circles V and VI in FIGS. 2 and 4, respectively.

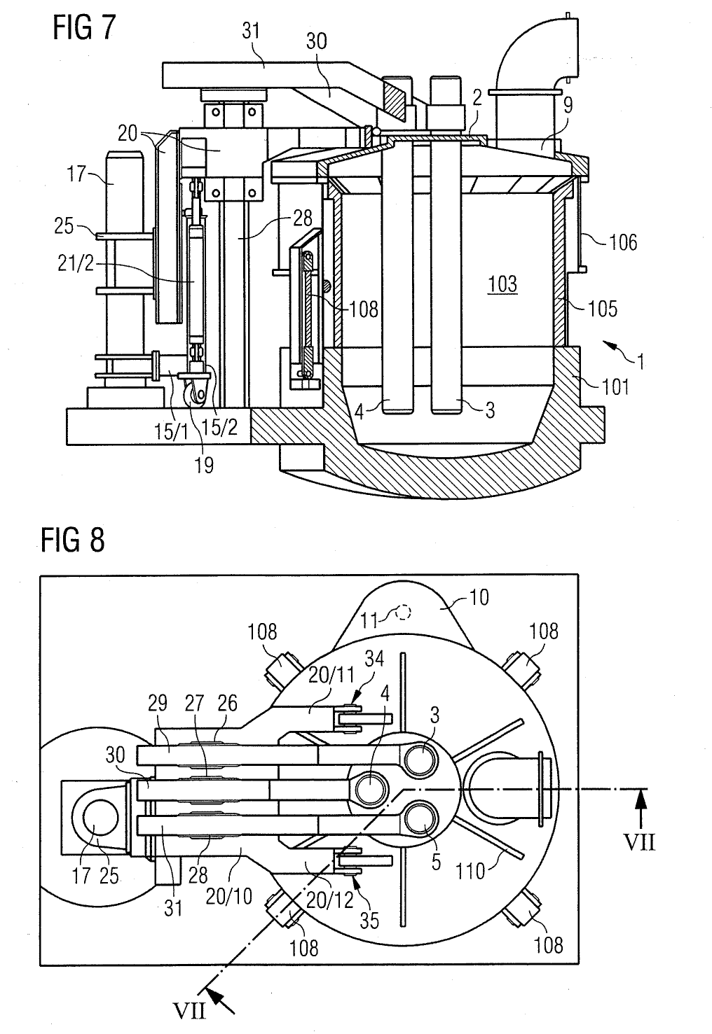

FIG. 7 shows a side view of a further embodiment of the invention, partially in cross-section along the line VII-VII of FIG. 8;

FIG. 8 shows a plan view of this embodiment, and

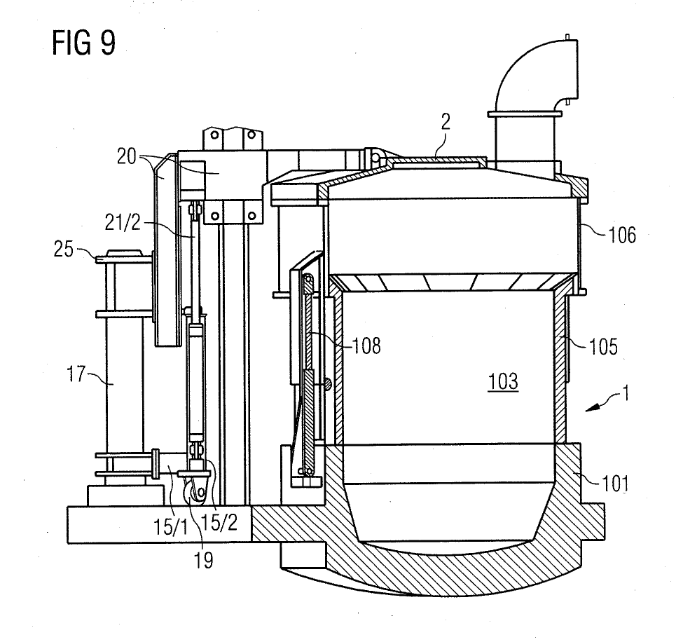

FIG. 9 shows a view of this embodiment corresponding to FIG. 7 with the upper segment of the upper furnace part lifted.

A melting furnace for melting-down iron-containing materials, such as steel scrap, comprises a furnace vessel 1 that is closable at its top by a cover 2. In an electric arc furnace, one electrode (direct-current electric arc furnace) or three electrodes 3, 4, 5 (three-phase alternating-current furnace) is/are respectively insertable through openings 6, 7 and/or a further, non-illustrated third opening into the interior of the furnace vessel for the melting and refining process. In general, an exhaust gas opening 9, which is connectable to an exhaust gas conduit, is also provided in the cover. Further, a tapping opening 11 is located in the floor or in a projection 10 of the vessel and a work opening 12 is located in the opposing vessel wall. The furnace vessel 1 is typically constructed to be tiltable. These features of a melting furnace and/or electric arc furnace are generally known, so that they are not described further and/or are not depicted in a detailed manner.

When the to-be-melted feedstock is to be introduced into the vessel from above, the cover and also the electrodes, in case of an electric arc furnace, must be removed from the vessel for the charging operation. For this purpose, a cover lifting and pivoting device 13 as well as an electrode lifting device 14 are provided in the present case; the electrode lifting device 14 is integrated in the cover lifting and pivoting device 13 in the present case.

The cover lifting and pivoting device for lifting, lowering and pivoting a cover 2 disposed on the furnace vessel 1 comprises a pivoting gantry 15 disposed to the side of the furnace vessel 1; the pivoting gantry 15 is rotatably borne by a pivot bearing 18 on a guide axis 17 that is oriented parallel to the central, vertical axis 16 of the furnace vessel 1 and is pivotable about the guide axis 17 using a not-illustrated drive. The pivoting gantry has the form of an L-shape in side view (see FIG. 2) with a horizontal leg 15/1, which supports the pivot bearing 18, and a vertical leg 15/2, which is supported on a roller 19.

In the present case, the cover lifting and pivoting device 13 comprises an L-shaped support part 20 having a cover supporting structure constructed with a horizontal leg 20/1 and a vertical leg 20/2. The support part 20 is liftable and lowerable by at least one lifting device. In the illustrated embodiment, there are two lifting devices, namely a rear lifting device 21/1 (see FIG. 2) and a front lifting device 21/2 (see FIG. 1). The lifting devices 21/1 and 21/2 are each disposed between the pivoting gantry 15 and the cover support structure 13 horizontally spaced apart from each other. In this particular case, they are each disposed between a bracket 15/22 of the vertical leg 15/2 of the pivoting gantry 15 and a bracket 20/13 of the horizontal leg 20/1 of the L-shaped support part 20. The brackets, which are not illustrated in the Figures, for rear lifting device 21/1 visible in FIG. 2 are constructed in an analogous manner and are mirror-images of the illustrated brackets 15/22 and 20/13 for the front lifting device 21/2.

For transmitting the pivoting movement of the pivoting gantry 15 to the support structure formed as the L-shaped support part 20, the vertical leg 20/2 of the support part 20 is connected with the vertical leg 15/2 of the pivoting gantry 15 by an engagement device 22 so as to rotate therewith. In the present case, the engagement device 22 is formed by a vertical groove 23 in the vertical leg 20/2 of the L-shaped support part 20 and an engagement projection 24 that is attached to the vertical leg 15/2 of the pivoting gantry 15 and engages in the vertical groove 23. The vertical guidance during lifting and lowering of the cover support structure 20 takes place via a bearing 25 attached at the bottom of the leg 20/2; the bearing 25 rotatably and axially-displaceably connects the cover support structure 20 with the guide axis 17.

The electrode lifting device 14 comprises three lifting columns 26, 27, 28 that support the support arms 29, 30, 31 for the electrodes 3, 4, 5, respectively, of the electric arc furnace and that are borne in the cover support structure 13, in particular in the horizontal leg 20/1 of the L-shaped support part 20. The electrode lifting device 14 is constructed in a known manner so that it does not require further explanation.

Because the lifting devices 21/2, 21/2 do not act at an end of the cover support structure as in known structures, but rather at the horizontal leg 20/1 of the same at a distance from the bearing 25 of the L-shaped support part 20 and, adjacent to the bearing point of the lifting columns 26, 27, 28, the bending stress of the cover support structure 13 during lifting of the cover support structure 13 can be substantially reduced in comparison with known structures. In the present solution, the segment of the support part 20, which is on the side facing away from the furnace cover, in essence the vertical leg 20/2 and the bearing 25 of the support part, form a counter weight to the weight load of the furnace cover and if provided, to the electrode lifting device borne in the support part.

In the illustrated exemplary embodiment, the horizontal leg 20/1 of the L-shaped support part 20 is formed U-shaped in plan view, with two support arms 20/11 and 20/12 (cf. FIGS. 1 and 3) connected by a base part 20/10; the support arms 20/11, 20/12 are disposed symmetrically relative to a first diametrical axis 32 of the cover 2 with a separation from each other.

The cover 2 is only partially traversed by the support arms 20/11 and 20/12 of the support part 20, in the present case not completely up to a second diametrical axis 33, which is perpendicular to the first diametrical axis 32 of the cover, and includes a cover suspending device 34, 35 near each free end of the support arms 20/11 and 20/12, respectively, of the support part 20; the cover suspending device 34, 35 is preferably constructed so as to be detachable. In the present case, eyelets are provided on the cover, in which, e.g., bolts actuatable by actuators are insertable, which bolts are attached to the free ends of the support arms 20/11 and 20/12 of the support part 20. Due to the asymmetric suspension of the cover, it is also necessary to provide a cover hold-down device in the edge area of the cover; the cover hold-down device is formed in the present case by a supporting projection 36 attached to the bottom of the base part 20/10 of the horizontal leg 20/1 of the support part 20; the supporting projection 36 produces a stable three point bearing of the cover together with the cover suspending devices 34 and 35. A precise vertical lifting of the cover is thereby facilitated.

For replacing the cover, the bolts of the cover suspending devices 34 and 35 are detached when the cover 2 is lying on the vessel edge; the support part 20 is lifted using the lifting devices 21/1 and 21/2 and is then pivoted to the side using the pivoting gantry 15.

In the inventive melting furnace, the furnace vessel formed from a lower vessel part 101 and a cylindrical upper vessel part 102 is constructed with an enlargeable, variable accommodation space 103 for the to-be-melted feedstock. For this purpose, the cylindrical upper vessel part 102 comprises, in addition to a typical wall segment 104, which is liquid-cooled if necessary and is set on the lower vessel part 101, a first, lower cylindrical segment 105 and an upper cylindrical segment 106, which overlaps the lower cylindrical segment 105 and is telescopically displaceable relative to the lower cylindrical segment 105. For this purpose, the upper cylindrical segment 106 of the upper vessel part 102 is attached to the edge of the furnace vessel cover 2 and is telescopically displaceable relative to the lower cylindrical segment 105 of the upper vessel part 102 by the cover lifting device acting upon the cover support structure 20, namely by the lifting devices 21/1 and 21/2. Consequently, the cover lifting devices 15/1 and 15/2 must be constructed with a correspondingly large lifting height. The lifting height must be so large that the upper segment 106 of the upper vessel part 102 attached to the cover edge can be lifted up over the upper edge of the lower vessel part 105, so that the cover can be pivoted for charging the feedstock. With respect to the filling of the vessel, in particular when the cover 2 has a flat construction, it is advantageous when the lower edge of the upper cylindrical segment 106 of the upper vessel cover 102 is liftable about 0.3 m to 0.8 m over the upper edge of the lower cylindrical segment 105.

FIG. 4 depicts the melting furnace with the upper cylindrical segment 106 in a lifted state. FIGS. 5 and 6, which are enlarged sections V and VI of FIGS. 2 and 4, allow the two positions to be recognized even more clearly. It is also apparent here that the upper edge of the lower segment 105 is provided with an annular flange 107 that simultaneously serves as a guide for the telescopic displaceability. At this point, or also at additional points, guide beads or similar guide elements can also be provided.

Although the upper vessel part 102 is formed from three cylindrical wall segments 104, 105 and 106 in the present case, the two stationary wall segments 104 and 105 could be combined into one stationary wall segment, such as, e.g., in the two embodiments according to FIGS. 7 and 9.

Further, the telescopic displaceability between the upper wall segment 106 and the lower wall segment 105 can be constructed so that the upper wall segment 106 is not telescopically displaceable outside of the lower wall segment 105, i.e. overlapping it, as in the illustrated exemplary embodiment, but rather inside of the same. This variant is not illustrated.

After charging the furnace vessel with the enlarged accommodation space, i.e. with the upper segment 206 lifted according to FIG. 4, craters are formed during the melting process by burning the electrodes into the feedstock material; the feedstock falls into the craters, so that the cover can be lowered and thus, a lowering of the electrodes is possible. Consequently, the vertical distance between the electrode tips and the (not-depicted) molten bath in the lower vessel part can be reduced to the position shown in FIG. 2.

In the exemplary embodiments depicted in FIGS. 7 and 9, the upper vessel part 106 is not attached to the edge of the cover 2, but rather is supported on four lifting devices 108 that are disposed in a distributed manner on the circumference of the furnace vessel 1. For the rest, the structure corresponds to the first exemplary embodiment, so that reference can be made to this embodiment for explanation.

1-14. (canceled)

15. A melting furnace comprising:
a furnace vessel including a lower vessel part and a cylindrical upper vessel part configured to accommodate feedstock, the cylindrical upper vessel part comprising a lower cylindrical segment and a upper cylindrical segment, wherein one of the cylindrical segments overlaps the other and one of the cylindrical segments is configured to be telescopically displaceable relative to the other,
a furnace vessel cover covering the furnace vessel,
a cover support structure supporting the furnace vessel cover and
at least one lifting device configured to telescopically displace one of the cylindrical segments relative to the other and to lift the cover support structure.

16. A melting furnace according to claim 15, wherein the upper cylindrical segment of the upper vessel part overlaps the lower cylindrical segment of the upper vessel part.

17. A melting furnace according to claim 16, further comprising a plurality of lifting devices disposed in a distributed manner around the circumference of the furnace vessel, the lifting devices being configured to lift and lower the upper cylindrical segment of the upper vessel part.

18. A melting furnace according to claim 15, wherein the upper cylindrical segment of the upper vessel part is attached to an edge of the furnace vessel cover and a cover lifting device acts upon the cover support structure and is configured to telescopically displace the upper cylindrical segment relative to the lower cylindrical segment of the upper vessel part.

19. A melting furnace according to claim 18, wherein a lower edge of the upper cylindrical segment of the upper vessel part is liftable about 0.3 m to 0.8 m over an upper edge of the lower cylindrical segment.

20. A melting furnace according to claim 15, further comprising at least one guide element provided on the upper edge of the lower cylindrical segment of the upper vessel part, the at least one guide element being configured to guide the upper segment of the upper vessel part during telescoping movement.

21. A melting furnace according to claim 15, wherein the furnace vessel cover is substantially flat and includes reinforcement ribs.

22. A melting furnace according to claim 15, wherein the cover support structure supporting the cover is axially-displaceably borne on a guide axis that is oriented parallel to a vertical, central axis of the furnace vessel and is disposed adjacent to the furnace vessel.

23. A melting furnace according to claim 22, further comprising a pivoting gantry supporting the lifting device for the cover support structure, wherein the pivoting gantry is disposed adjacent to the furnace vessel, is rotatably borne on the guide axis of the cover support structure and is pivotable about the guide axis, and wherein the cover support structure supporting the cover is rotatably borne on said guide axis and is rotatably connected with the pivoting gantry via an engagement device.

24. A melting furnace according to claim 23, further comprising a hollow cylinder attached to the cover support structure, the hollow cylinder being rotatably borne on said guide axis.

25. A melting furnace according to one of claims 24, wherein the cover support structure comprises an L-shaped support part having at least one horizontal leg at least partially traversing the cover.

26. A melting furnace according to claim 25, further comprising:
cover suspending devices providing at each side of a diametrical axis of the cover on the L-shaped support part near a free end of the horizontal leg and
a cover hold-down device provided above and adjacent the cover edge.

27. A melting furnace according to claim 26, wherein the cover suspending device comprises a bolt/eyelet connection actuatable by an actuator.

28. A melting furnace according to claim 27, wherein the cover support structure supports at least one electrode lifting device.

29. A melting furnace according to claim 28, further comprising at least one electric arc electrode penetrating through the furnace vessel cover.

30. A melting furnace according to claim 15, further comprising at least one electric arc electrode penetrating through the furnace vessel cover.

31. A melting furnace according to claim 30, wherein the cover support structure supports at least one device configured to lift at least one electric arc electrode.

32. A melting furnace according to claim 15, further comprising at least two lifting devices distributed around the circumference of the furnace vessel, the lifting devices being configured to lift and lower the upper cylindrical segment relative to the lower cylindrical segment.

33. A melting furnace comprising:
a furnace vessel including a lower vessel part and a cylindrical upper vessel part configured to accommodate feedstock, the cylindrical upper vessel part comprising a lower cylindrical segment and an upper cylindrical segment, wherein one of the cylindrical segments overlaps the other and one of the cylindrical segments is configured to be telescopically displaceable relative to the other, and
a furnace vessel cover covering the furnace vessel and being movable with the upper cylindrical segment.

34. A method for melting a feedstock in a melting furnace comprising a lower vessel part and a cylindrical upper vessel part configured to accommodate the feedstock, the cylindrical upper vessel part including a lower cylindrical segment and an upper cylindrical segment, which are telescopically displaceable relative to each other, the method comprising:
charging an interior space of a furnace vessel with the feedstock, and
melting the feedstock while simultaneously reducing the interior space by lowering the upper cylindrical segment relative to the lower cylindrical segment.
